(19) United States
(12) Patent Application Publication
(10) Pub. No.: US 2010/0142402 A1
(43) Pub. Date: Jun. 10, 2010

(54) Method, Apparatus and Computer Program Product for Determining A Master Module in a Dynamic Distributed Device Environment

(76) Inventors: Sergey Boldyrev, Soderkulla (FI); Ian Justin Oliver, Soderkulla (FI); Jukka Honkola, Espoo (FI)

Correspondence Address: DITTHAVONG MORI & STEINER, P.C., 918 Prince Street, Alexandria, VA, 22314, US

(21) Appl. No.: 12/329,217

(22) Filed: Dec. 5, 2008

(51) Int. Cl. H04L 12/28

(52) U.S. Cl. 370/254

(57) ABSTRACT

An apparatus for determining a master module in a dynamic distributed device environment may include a processor. The processor may be configured to calculate a connectivity stability factor for a module. The module may be included on a device configured to be connected to a distributed device network. The distributed device network may be defined as a network where devices leave or enter the network at any time, such as a smart space. The processor of the apparatus may also be configured to weigh the connectivity stability factor of the module against neighboring connectivity stability factors associated with neighboring modules, and assign a role of master module to the module based on a determination that the connectivity stability factor of the module describes a more stable module than the connectivity stability factors of the neighboring modules. Associated methods and computer program products may also be provided.

### TECHNICAL FIELD

Embodiments of the present invention relate generally to network connectivity analysis, and, more particularly, relate to a method, apparatus, and a computer program product for determining a master module in a dynamic distributed device environment.

### BACKGROUND

The modern communications era has brought about a tremendous expansion of wireless networks. Various types of networking technologies have been and are being developed resulting in unprecedented and increasing expansion of computer networks, television networks, telephony networks, and other communications networks. As new networking technologies evolve, consumer demand continues to fuel increased innovation with respect to utilization of networks. Wireless and mobile networking technologies continue to address related consumer demands, while providing more flexibility and immediacy of information transfer.

As the flexibility and functionality of mobile communications devices increases, options for networking technologies continue to evolve. For example, the technology associated with dynamic distributed device networks or dynamic architecture networks, such as smart spaces, are becoming increasingly practical due to the evolution of mobile communications devices.

A smart space may be an environment where a number of devices may use a shared view of resources and services to access information within the environment. In this regard, smart spaces can provide improved user experiences by allowing users to flexibly introduce new devices and access most or all of the information available in the dynamic multiple device environment from any of the devices within the environment. However, problems with information management and message routing in smart spaces can arise because smart spaces do not have a static network topology. As a result, difficulties arise with determining the location of desired information and/or the presence of intended recipients in the network. Further, the prediction of efficient paths for routing messages, such as requests for information in the smart space can also be problematic since the connectivity and the topology within the smart space cannot be assured.

### BRIEF SUMMARY

A method, apparatus, and computer program product are described that determine a master module within a dynamic distributed device environment, such as a smart space or other dynamic distributed device network. The master module may be one of a plurality of modules that are part of the network. Modules may be components of the network that provide information sharing in an agent-style to support dynamic, fluid storage and retrieval of information within the network. Modules also provide connectivity to the network and may act as connectivity intermediaries to other modules, nodes (e.g., applications), and information stores. Modules may join or leave the network at any time. An example of a module with a smart space is a semantic information broker (SIB).

To facilitate the routing of messages within a dynamic distributed device environment, a connectivity topology may be generated. The connectivity topology may be utilized by a master module to efficiently route messages within the network based on a predetermined strategy. Since the connectivity of the network is dynamic, the master module may be the module that exhibits the maximum connective stability within the network at some instant in time. To identify the master module, a stability analysis may be undertaken. Each module within the network may calculate a connectivity stability factor. The connectivity stability factors may be compared to identify the module that is most stable. The most stable module may then be assigned the role of master module. Since the network is dynamic, the stability analysis may be continuously repeated to ensure that the most stable module is the master module. As such, due to changes in the network and accordingly changes in the stability of the network, the role of master module may migrate amongst the modules of the network.

An effect of some example embodiments of the invention is to provide for a stable means for information and messaging management in a dynamic distributed device environment. In this regard, example embodiments leverage information dissemination throughout the network to determine the stability of the network and provide for determining a reliable topology of the network. Example embodiments are also beneficial because they allow for efficient routing of relevant requests for information to the appropriate entities to thereby minimize or otherwise reduce energy utilization within the network. Further, example embodiments of the present invention are scalable to any size network and may be utilized on a variety of computing platforms.

In this regard, in one example embodiment, a method for determining a master module in a dynamic distributed device environment is provided. The example method includes calculating a connectivity stability factor for a module. In this regard, the module may be included on a device configured to be connected to a dynamic distributed device network. The example method also includes weighing, on a processor, the connectivity stability factor of the module against neighboring connectivity stability factors associated with neighboring modules, and assigning a role of master module to the module based on a determination that the connectivity stability factor of the module describes a more stable module than the connectivity stability factors of the neighboring modules.

In another example embodiment, an apparatus for determining a master module in a dynamic distributed device environment is provided. The example apparatus includes a processor. The processor may be configured to calculate a connectivity stability factor for a module. In this regard, the module may be included on a device configured to be connected to a dynamic distributed device network. The processor may also be configured to weigh the connectivity stability factor of the module against neighboring connectivity stability factors associated with neighboring modules, and assign a role of master module to the module based on a determination that the connectivity stability factor of the module describes a more stable module than the connectivity stability factors of the neighboring modules.

Another example embodiment is a computer program product. The computer program product may include at least one computer-readable storage medium having executable computer-readable program code instructions stored therein. The computer-readable program code instructions may be configured to calculate a connectivity stability factor for a module. In this regard, the module may be included on a device configured to be connected to a dynamic distributed device network. The computer-readable program code instructions may also be configured to weigh the connectivity stability factor of the module against neighboring connectivity stability factors associated with neighboring modules, and assign a role of master module to the module based on a determination that the connectivity stability factor of the module describes a more stable module than the connectivity stability factors of the neighboring modules.

Yet another example embodiment is an apparatus. The example apparatus includes means for calculating a connectivity stability factor for a module. In this regard, the module may be included on a device configured to be connected to a dynamic distributed device network. The example apparatus also includes means for weighing the connectivity stability factor of the module against neighboring connectivity stability factors associated with neighboring modules, and means for assigning a role of master module to the module based on a determination that the connectivity stability factor of the module describes a more stable module than the connectivity stability factors of the neighboring modules.

### BRIEF DESCRIPTION OF THE DRAWING(S)

Having thus described the invention in general terms, reference will now be made to the accompanying drawings, which are not necessarily drawn to scale, and wherein:

FIG. 1 is an illustration of a smart space in accordance with various example embodiments of the present invention;

FIGS. 2a-2c are illustrations that collectively depict the formation of a smart space according to various example embodiments of the present invention;

FIGS. 3a-3b are illustrations that collectively depict a SIB joining an existing smart space according to various example embodiments of the present invention; and

FIGS. 4a-4b are illustrations that collectively depict a master SIB takeover according to various example embodiments of the present invention;

FIGS. 5a-5b are illustrations that collectively depict the occurrence of a disjoint in a smart space according to various example embodiments of the present invention;

FIG. 6 is a flowchart depicting the operation of a SIB within a smart space according to various example embodiments of the present invention;

FIG. 7 is block diagram representation of an apparatus for determining a master module in a dynamic distributed environment according to various example embodiments of the present invention; and

FIG. 8 is a flowchart of a method for determining a master module in a dynamic distributed environment according to various example embodiments of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, operated on, and/or stored in accordance with embodiments of the present invention. As used herein, the terms “request,” “message,” and similar terms may be used interchangeably to refer to communications within a smart space in accordance with embodiments of the present invention. Moreover, the term “exemplary,” as used herein, is not provided to convey any qualitative assessment, but instead to merely convey an illustration of an example.

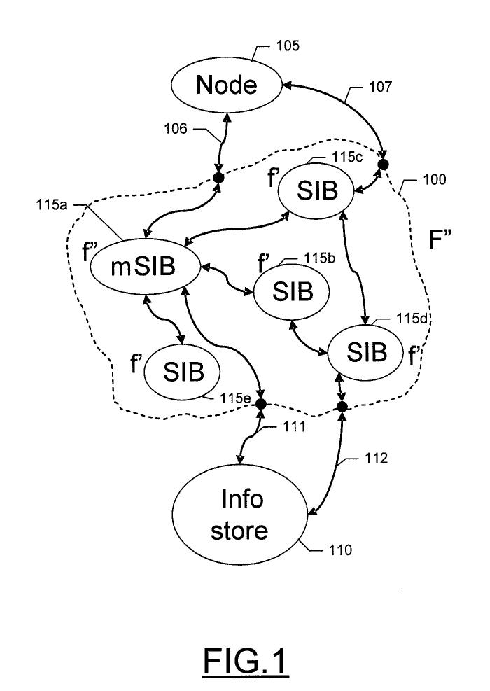

FIG. 1 is an illustration of an example smart space 100 in accordance with exemplary embodiments of the present invention. The smart space 100 is connected to a node 105 (via connections 106 and 107) and an information store 100 (via connections 111 and 112). The smart space 100 is comprised of a plurality of semantic information brokers (SIBs) 115 (e.g., SIB 115a, SIB 115b, SIB 115c, SIB 115d, and SIB 115e). Smart space 100 is a dynamic, ad hoc, distributed device network having a dynamic topology where any device may leave or enter the network at any time.

The node 105 may be representative of one or a plurality of nodes that operate in conjunction with the smart space 100. Node 105 may provide the basis for various functionalities within the smart space 100. In this regard, a node may be any application or portion of an application executed by a device connected to the smart space 100. In this regard, a node may be aware of other nodes of the smart space, such as adjacent nodes. The application of a node may be any application that may implement storing, retrieving, computing, transmitting, and receiving information. In various embodiments, the node 105 may be representative of applications being executed by various devices, such that in some exemplary embodiments, node 105 may be executed by the same device, and one device may execute a plurality of nodes. Further, in some embodiments, a single node may be implemented by more than one device such that the devices share the node.

A node may include an external interface, a node information store interface, and a task. The external interface may consider a node's interaction with the external world (e.g., a user). The node information store interface may be used to transfer information to and retrieve information from an information store (e.g., information store 110) via the smart space. The task may define a relationship between the external interface and the node information store interface. For example, if a user wishes to retrieve some information from an information store to a node, a task for the retrieval (e.g., a query message) may be generated. A node may interact with an information store in various manners. In this regard, a node may insert information, remove/retract information, query information, subscribe to an information store by means of the persistent query (e.g., a subscription), and cancel such subscriptions (e.g., unsubscribe). The various types of interactions between the nodes and the information stores may be collectively referred to as requests. A node may communicate the requests to the information store via the smart space, and receive information from the information store via the smart space. A node may be aware of the smart space generally, but need not be aware of the connectivity within the smart space, such as for example, that the node is connected to the smart space via a particular SIB.

Any device connected to smart space 100 may implement an information store such as the information store 110. In this regard, the devices implementing an information store may be capable of storing, retrieving, computing, transmitting, and receiving information. Accordingly, in some embodiments, an information store may be a logical entity describing a location where information may be stored. According to various embodiments, an information store may span a plurality of devices. The information stores may store information associated with the smart space 100 and information that may be accessed via the smart space 100.

A mentioned above, SIBs 115 provide a link between the node 105 and the information store 110. SIBs may be virtual entities of the smart space 100, and one SIB may be representative of a plurality of SIBs. A SIB, which is a type of module, may be a part of the smart space infrastructure that provides information sharing (e.g., between the node 105 and the information store 110) in an agent-style fashion. In this manner, SIBs may provide a more dynamic, fluid management of information within the smart space. In some exemplary embodiments, SIBs receive all messages arriving at any SIB within the smart space and all messages passed on by a SIB (e.g., to a node or information store) appear to come from the smart space. SIBs may be configured to include functionality such as, schedulers, information managers, listeners, and connectors to an information store or node. SIBs may be configured to manage the entry (joining) and exit (leaving or quitting) of entities to and from the smart space 100. Further, SIBs may also manage information manipulation within the smart space 100, such as insert messages, retract messages, query messages, subscribe and unsubscribe messages. SIBs may be implemented by an underlying device and one or more SIBs may be implemented by the same device.

A node and/or an information store may connect to smart space 100 via a SIB. Interaction between a node or an information store and a SIB may be anonymous, since any SIB may provide a connection to the smart space for a node or information store. Further, a node or information store may be connected to a smart space via more than one SIB. In the example smart space 100, the node 105 is connected to the smart space via SIB 115a and SIB 115b and the information store 110 is connected to the smart space 100 via SIB 115a and SIB 115b. Further, SIBs may be interconnected with each other within the smart space 100. As such, a smart space may be represented by the SIBs and the total possible connectivity of the smart space may be given by the distributed union of the SIBs, or at least the SIBs that include listeners. Further, SIBs may communicate internally to ensure membership and credentials of nodes (e.g., node 105) and other SIBs. In this regard, from the perspective of a node, available information may be the distributed union over the transitive closure of routes between all SIBs. For this reason, in some example embodiments, the SIBs may include routing tables to other SIBs. As a result, within a smart space, all the SIBs are routable, but need not be totally connected (e.g., there need not be connection between every SIB of the smart space).

The connectivity of the SIBs to each other and to nodes and information stores can be based on a number of factors. Since connections between nodes, information stores and SIBs are based on underlying communications connections between or within devices, the connectivity of the nodes, information stores, and SIBs may be based on the connectivity of the devices that implement these entities. As such, the factors that affect the connectivity of devices (e.g., signal strength, system congestion, processing power, connection protocol, etc.) also affect the connections between nodes, information stores, and SIBs within the smart space. Also, due to the dynamic nature of the smart space 100, the reliability of connections within the smart space is not guaranteed. As a result, stability of connectivity within a smart space can play an important role in keeping the smart space operating efficiently. Formulating a concept of connectivity stability within the smart space can also provide for determining a current topology of the smart space for use in routing messages or requests within the smart space.

The SIBs may reside in a virtual entity referred to as the connectivity controller and receive information for connectivity stability analysis from the connectivity controller. The connectivity controller may implement a network specific domain analysis which may be based on, for example, interface properties between entities of the smart space, adjacent entity properties, last action types, timestamps of the last actions, node access information, and/or the like. This and other information may be provided by a connectivity controller to the SIBs. The connectivity controller may reside on each device within the smart space and the connectivity controller may span to encompass all of the devices of the smart space. In some example embodiments, the connectivity controller resides on a single device that may be accessed by other network entities. Further, in some exemplary embodiments, the connectivity controller may be a software application executed by the aforementioned devices.

In this regard, the connectivity controller may be aware of its surrounding environment and network topology in addition to its local connectivity capabilities. The connectivity controller may also be aware of physical limitations of the various individual devices connected to the smart space, or the devices within the wireless range of the connectivity controller. In this regard, the connectivity controller may determine abstract connectivity properties of the devices participating in the smart space. Additionally, the connectivity controller may hide the complexity of multitransport control mechanisms by providing a connectivity cost function interface to the SIBs within the smart space.

The connectivity controller may include a multiradio controller function in the time domain that may be responsible for allocating connectivity resources based on the communication medium activity, resource availability, wireless spectrum availability, and/or the like. In this regard, the connectivity controller need not have a direct effect on the interface provided to the distribution framework.

Further, the connectivity controller may implement protocols and data types for creating a network topology map and connectivity technology map of the smart space. The network topology map and the connectivity map may enable power efficient transport selection upon data delivery. Also, connectivity map protocols may be used to share information about the physical properties of each device connected to the network such as, for example, remaining battery life, available memory resources, computational capabilities, and/or the like.

An advantage of implementing the connectivity controller as described may be that the presence of multitransport devices and/or heterogeneous networking technologies may be used to perform one data delivery task. For example, due to the dynamic nature of ad hoc networks (e.g., smart spaces) the initial data delivery from one entity to another may be done with Bluetooth, but when the receiving entity moves out of the range of the Bluetooth radio, the connectivity controller may open another connection between the entities using, for example, WLAN and continue the data delivery. The decision of such intersystem handover may be done based on the connectivity map information and physical characteristics of the participating entities. For more information regarding the operation of a connectivity controller, see Method, Apparatus, and Computer Program Product for Distributed Information Management, application Ser. No. 12/144,726, filed Jun. 26, 2008, which is herein incorporated by reference in its entirety.

Based on the information available to the SIBs via the connectivity controller, a connectivity stability factor may be calculated for each SIB within the network. The connectivity stability factor may be calculated by performing a superposition operation on information available via the connectivity controller. The calculation of the connectivity stability factor may also consider additional connectivity information that need not have been provided by the connectivity controller (e.g., connectivity information provided directly from another SIB). Based on the connectivity stability factor, a stable SIB may be defined. A stable SIB may be a SIB having a connectivity stability factor that exceeds a threshold connectivity stability factor. By defining a stable SIB in this manner, real-time optimization of the smart space may be realized.

The connectivity stability of the smart space may be defined by the connectivity stability of the most stable SIB within the smart space. Referring again to FIG. 1, the connectivity stability of the smart space 100 is represented by F″. In this regard, SIB 115a has a connectivity stability factor of f′, which is greater than the connectivity stability factor of the other SIBs, which have a connectivity stability of f′. As such, the connectivity stability of the smart space 100 is F″.

As the most stable SIB within the smart space 100, SIB 115a may be assigned the role of the master module, or master SIB (mSIB). In some example embodiments, more than one mSIB may be defined, for example, as two or more SIBs having the highest connectivity stability factors. The most stable SIB may be identified as the most stable SIB within a group of stable SIBs, or neighboring SIBs, as defined by SIBs having connectivity stability factors above a given threshold. The mSIB may be an adaptive designation since the topology of the smart space is dynamic. As such, the role of mSIB may migrate throughout the smart space based on the connectivity stability of the SIBs at any one instant in time. In this regard, SIBs may be regularly, or irregularly, challenging the mSIB based on recalculations of respective connectivity stability factors. In some example embodiments, regular challenging of the mSIB may be based on a heartbeat period for the smart space as, for example, provided by a heartbeat message.

An mSIB may be considered the most reliable connection point within the smart space at an instant in time. As such, the mSIB may conduct communication management within the smart space. Through the connectivity controller and information being provided to the connectivity controller, by for example, the other SIBs, the mSIB may route messages, or packets, within the smart space. In this regard, the mSIB may leverage the abstraction of SIB addressing (via identifiers or keys) within the smart space to determine whether a SIB should process a particular message or pass the message along to another SIB, node, or information store. In this manner, the mSIB may manage the communication of messages to appropriate SIBs (e.g., SIBs that are configured to process a particular message type) to efficiently route messages within the smart space and also perform workload balancing amongst the SIBs.

Implementation of the role of mSIB in various example embodiments solves the problem of distributing information and queries in a consistent manner across multiple computation elements making up the information processing system of the smart space. Further, the implementation of an mSIB, according to various example embodiments, also allows for deductive closure of information at run-time and provides for efficient processing of requests using the most stable set of information. Through the use of an mSIB and connectivity stability factors, various strategies for information management may be considered. For example, under one example strategy, insert messages and retract messages to an information store may be distributed around the entire smart space, while query messages may be routed to more stable SIBs. On the other hand, under a second strategy, insert messages and retract messages to an information store may be routed to more stable SIBs, while query messages may be distributed around the entire smart space. Further, balancing between these two strategies may also be performed as an alternative strategy.

Through implementation of the mSIB, various approaches to maintaining the infrastructure of the smart space may be implemented. In a first approach, all SIBs may receive all packets and apply an incremental routing technique to forward a message to the appropriate SIB. In a second approach, an mSIB manages and determines the messages to be sent and forwarded to the appropriate SIBs. And, in a third approach, when the SIB routing mechanism has query update capabilities, then the mSIB may be implemented and the routing technique may be extended by local information that a particular SIB can provide. In this regard, the mechanism for determining which SIB is to process a message and which SIB is to disregard the message may be based on incremental key routing.

As described above, the mSIB may be grouped with neighboring SIBs. In this regard, neighboring SIBs need not be proximate or adjacent SIBs, but rather SIBs that have a connectivity stability factor greater than a threshold. As such, a stable group of SIBs may be defined, which may also define the group of SIBs included in the smart space. The members of the group may recalculate respective connectivity stability factors and challenges for the role of mSIB may be conducted within the group. In some example embodiments, the agreement of a quorum of the group members may be needed to reassign the role of mSIB within the group.

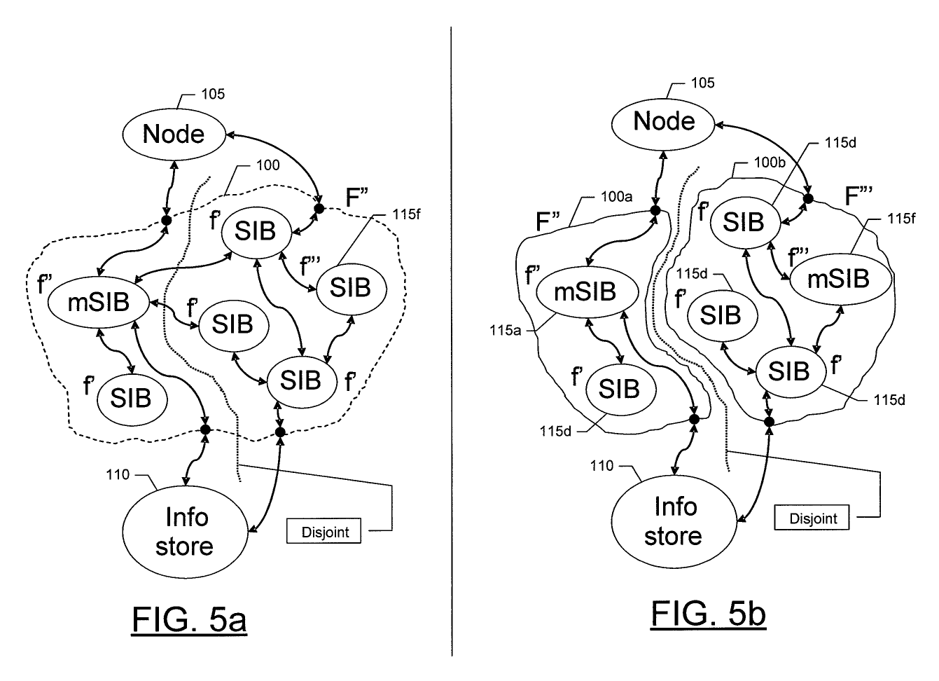

In some instances, the stability connectivity factor of one or more SIBs may fall below a threshold, or connectivity with one or more SIBs of the group may be lost. As a result, a disjoint in the group may be generated and these SIBs may no longer be members of the group. The lost members may, in turn, generate a new group (e.g., a new smart space) and assign a new mSIB within the separated group. The separated group may each define a quorum of members that have a threshold level of stability as a group. The quorum members may then use information provided by SIBs outside of the quorum to rejoin lost members of the original group, if possible. In some instances, the occurrence of a disjoint may affect the operation of the smart space, particularly if a connection between a node and an information store is lost as a result of the disjoint. An example of a disjoint situation is described further below with respect to FIGS. 5a and 5b.

Referring again to the operation of the mSIB and the mSIB's responsibilities with respect to information and communication management within the smart space, the mSIB may be responsible for routing and managing messages of three types, that is, distributed infrastructure management messages, management store messages, and query messages.

The distributed infrastructure management messages may be used to maintain neighbor descriptors and incremental routing tables and may be used to support store and query messages. Distributed infrastructure management messages may be basic elements of synchronization protocol between the SIBs. An incremental routing table may be maintained to describe a neighbors list. In this regard, maintenance messages, such as join, leave, heartbeat, heartbeat timeout, send, notify and forward may be utilized. A cache for previously constructed routes may also be maintained, and as such messages may be routed directly, without lookup within the distributed infrastructure.

Further, to provide information about connectivity parameters of any SIB, the heartbeat message may be used. To navigate around the SIBs, two lists may be constructed and used. The first list may be based on the neighbors list, and that first list may be in charge of any successor routing, such as through implementation of a send message. The second list may be used to improve overall performance and leverage the workload amongst the SIBs. The second list may include exponentially distributed identifiers and/or keys of all other SIBs.

The store message group may be used to pass information to the SIBs. The store message group may include an insert and remove (or retract) message, which provide for distribution of information. The query message, described further below, presents a manner of distribution which is applicable to the store group messages.

The query message group may be used to pass a query to the SIBs for any particular information as well as subscriptions to the SIBs. In this regard, subscribe and unsubscribe messages may provide for the distribution of the persistent or repeated queries. The query message may present a way of distribution of information, which may be applicable to all query group messages. The query message may be routed to any other SIB. The query message can be forwarded by any other SIBs according to the incremental routing table, finger table, and/or routing decision. In the case of a message forward, notification may be generated by a SIB and the notification may be used to override routing decisions. In some example embodiments, a decision for routing is obtained by means of information regarding the current network conditions. As such, a query message may pass a particular SIB only once. Therefore the query route construction may converge to an efficient query forwarding mechanism based on the network topology. The response to a query message group message may be returned by means of a deliver message, which returns requested information.

The mSIB may also have distributed infrastructure managing responsibilities. In this regard, the mSIB may receive a join message for a SIB attempting to join the smart space. The join message may include an authentication portion to be used to authenticate the identity and, possibly the trustworthiness of the SIB attempting to join the smart space. When the mSIB receives a join message, the mSIB may perform a check of the message against an authentication mechanism, and if the message fails, the mSIB may prevent the SIB from joining the smart space. If the join message is authenticated, the mSIB may send a confirmation message and allow the SIB to join the smart space. When the confirmation to join message is received, the SIB attempting to join the smart space may become a confirmed SIB within the smart space.

Further, distributed infrastructure management at the SIB level may be driven by the exchange of a heartbeat message between SIBs. Each SIB may include a timer to track heartbeat messages. The event of receiving a heartbeat message from the mSIB or any neighbor SIB within a certain period of time may be tracked. Regarding mSIB to SIB interaction, there may be several cases when a SIB should execute a join message. For example, a join message may be executed if a timer expires because no heartbeat message is received in a given period of time from the mSIB. Failure to receive a heartbeat message from the mSIB may indicate that the mSIB is down and the SIB should rejoin the SIB distributed infrastructure. Alternatively, if a SIB receives a quit message, the SIB should leave the SIB distributed infrastructure and may attempt to rejoin.

If a SIB sending a join message doesn't receive a confirmation message, the SIB may broadcast messages offering to become the mSIB, after having calculated a connectivity stability factor. If the SIB receives an mSIB exists message, the SIB may attempt to join again with the preserved connectivity stability factor. If after the SIB broadcasts the messages offering to become the mSIB, the SIB receives no response, within predetermined amount of time, the SIB may send broadcast responses to inform the other SIBs in the SIB distributed infrastructure of the new credentials of the mSIB, and the SIB may assume the role of mSIB. If there is response from an mSIB, and if the connectivity stability factor is above the threshold to become mSIB or the SIB is more stable than the current mSIB, the SIB may send broadcast responses to inform the other SIBs in the SIB distributed infrastructure of the new credentials of the mSIB, and the SIB may assume the role of mSIB. If during the process of mSIB handover, a SIB receives a quit message, the SIB may leave and attempt to join again.

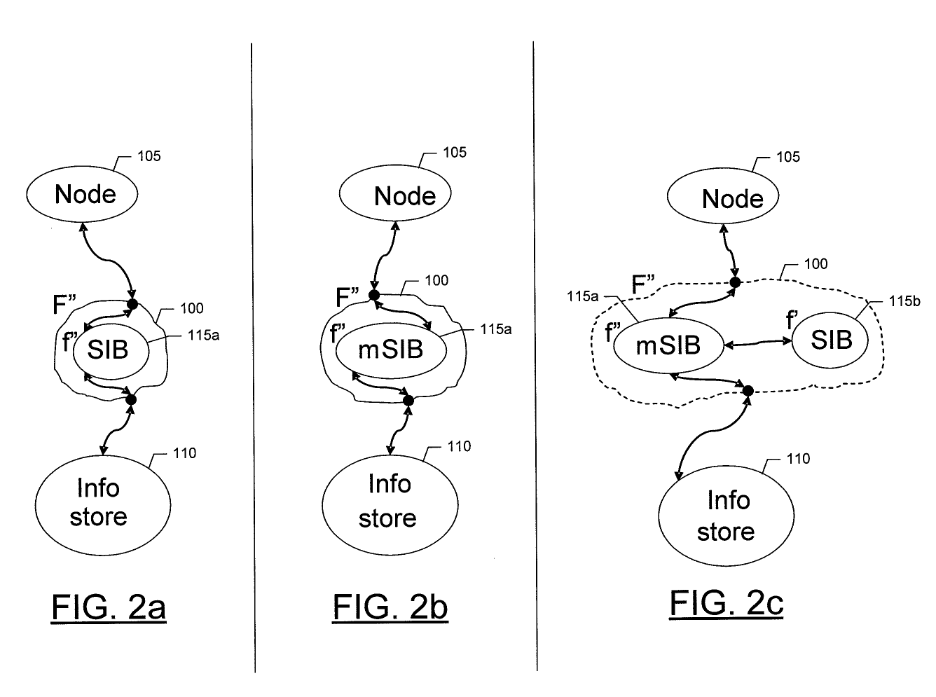

Based on the foregoing, FIGS. 2a through 2c illustrate the formation of a smart space according to various example embodiments of the present invention. FIG. 2a illustrates the smart space 100 with a single SIB 115a connected to node 105 and information store 110. The smart space 100 has a connectivity stability factor F″ based on the connectivity stability factor of the SIB 115a, namely f′.

FIG. 2b illustrates the evolution of the only SIB within the smart space 100, SIB 115a, becoming the mSIB. FIG. 2c illustrates the smart space 100 after another SIB 115b has joined the smart space. A connectivity stability calculation has been performed and a determination has been made that SIB 115a, with a connectivity stability factor of f″, is more stable than SIB 115b with a connectivity stability factor of f′. As a result, SIB 115a maintains its role as the mSIB.

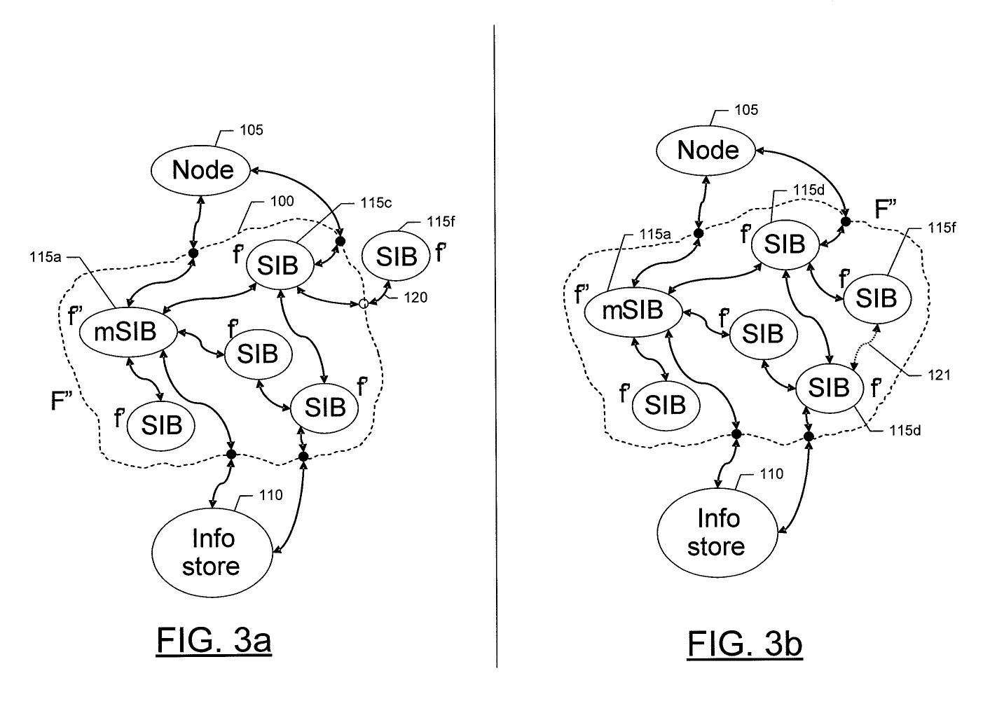

FIGS. 3a and 3b illustrate the joining of a SIB to an existing smart space 100. Referring to FIG. 3a, SIB 115f generates a connection 120 with SIB 115c and sends a join message. In the example of FIG. 3a the join message is confirmed and SIB 115f is allowed to join the smart space 100. SIB 115f may also begin sending and receiving heartbeat messages. Referring now to FIG. 3b, SIB 115f has become a part of the smart space 100. Via for example, the heartbeat messages, information from the connectivity controller, or other information for the SIBs, SIB 115f may have also identified a new connection 121 with SIB 115d.

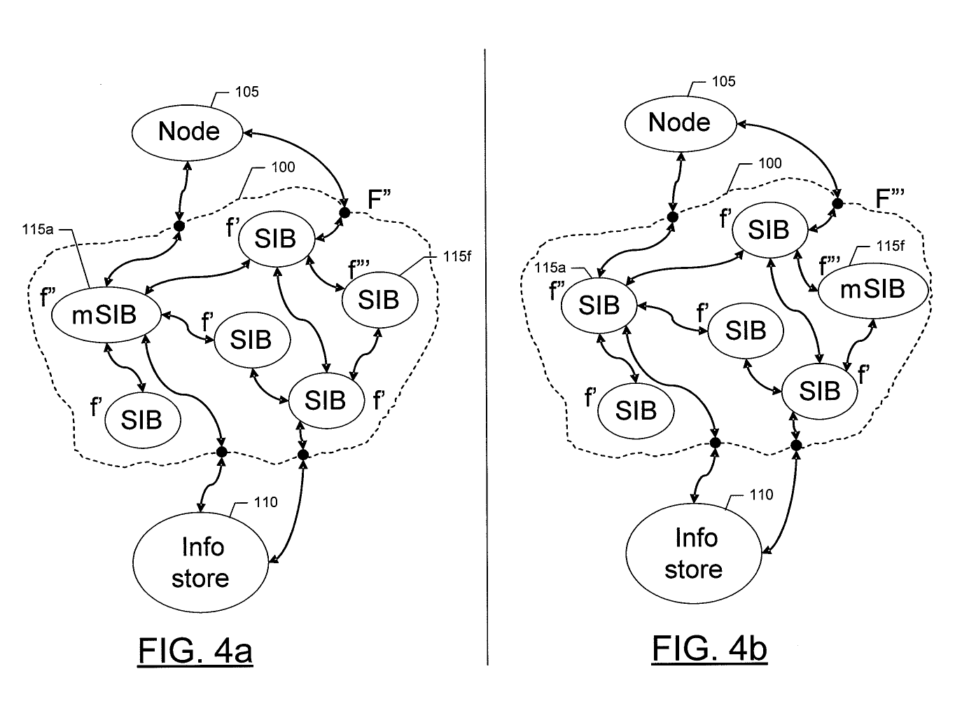

FIGS. 4a and 4b illustrate a handover of the mSIB to another SIB. In FIG. 4a, SIB 115a is the mSIB with a connectivity stability factor of f″. Upon recalculation in this illustrated embodiment, it is determined that SIB 115f has a connectivity stability factor of f″, which describes a more stable SIB than SIB 115a. In this regard, a challenge between SIB 115f and 115a may occur. SIB 115f may send a master request, and upon determining that a master exists, the respective connectivity stability factors may be weighed. Referring to FIG. 4b, the role of mSIB has been passed to SIB 115f and the connectivity stability factor of the smart space 100 becomes F″′. SIB 115 may send out a new master message with credentials to the SIBs of the smart space.

FIGS. 5a and 5b illustrate a disjoint scenario. In FIG. 5a, a disjoint occurs, for example, because connectivity between particular SIBs is instable or lost. In some embodiments, the existence of two similarly stable SIBs may also result in a disjoint. As a result, in FIG. 5b, two smart spaces are formed, namely 100a and 100b. In response to the loss of a heartbeat message from mSIB 115a, the members of smart space 100b may assign the role of mSIB to SIB 115f. The two separate smart spaces may continue to operate in a separated fashion, or the SIBs that form one of the smart spaces may send join messages to individually rejoin the other smart space.

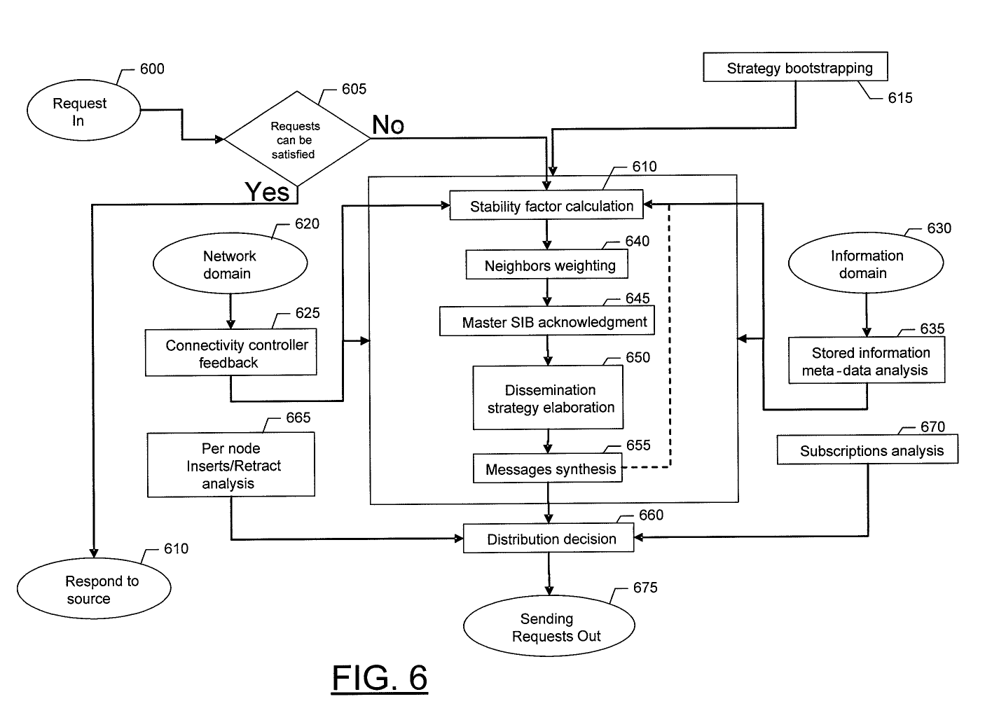

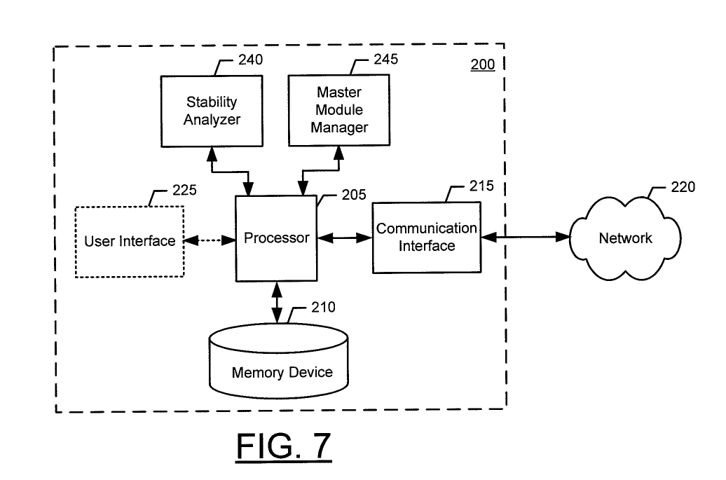

Referring now to FIG. 6, a method for determining a master module within a dynamic distributed device environment is provided. According to various embodiments, the method of FIG. 4 may be implemented by an apparatus including a processor configured to implement the method, such as, apparatus 200 of FIG. 7. At 400, requests or messages (e.g., query messages) may be received. In this regard, the request may include data that indicates the initial route. In some embodiments, the initial route may be determined based on a previous path update or based directly on a topology map. In this regard, the initial route may be subject to further optimization. At 605, a determination may be made regarding whether the request can be satisfied. In this regard, a SIB may analyze the request and determine if the request may be satisfied based on connectivity information available to the SIB. If the request can be satisfied, then a response may be provided to the source (e.g., a node) at 610.

If the request cannot be satisfied a route update may be determined to intelligently route the request. In this regard, a connectivity stability factor calculation may be implemented at 610. The connectivity stability factor calculation may be based upon strategy bootstrapping provided at 615.

In some exemplary embodiments, the connectivity stability factor calculation may be performed based on information from two sources. The two sources may be an information domain (e.g., a data specific domain) that provides meta-data, including actual content and query related content, and a network domain (e.g., a network specific domain) that provides information gathered regarding the network and the connectivity of the network from a network domain. Data specific information may be delivered by a distributed object file system infrastructure and may include meta-data object distribution and hierarchy. Network specific information may be delivered by a connectivity layer, via, for example, the connectivity controller, and may include actual network topology, network conditions, and traffic pattern information. As such, calculating a connectivity stability factor may converge based on the two domains' information analysis (e.g., network domain analysis and information domain analysis) and fusion of information from these domains.

In this regard, data for calculating the connectivity stability factor may be provided by the information domain 630. A stored information meta-data analysis of data from the information domain may be performed at 635 and provided for connectivity stability factor calculation. Additionally, data may be provided from a network domain at 620. In this regard, a connectivity controller may provide feedback at 625 and provide the result for connectivity stability factor calculation.

Upon calculating the connectivity stability factor at 610, a neighbors weighing may occur at 640. In this regard, the connectivity stability factor may be weighed against the connectivity stability factors of other modules or SIBs to determine whether the connectivity stability factor describes a module that is more stable than the neighboring modules. At 645, a master module or SIB acknowledgement may be performed. In this regard, if the connectivity stability factor describes a module that is more stable than the neighboring modules, the module performing the method of FIG. 6 may be assigned the role of master module. The module may communicate and acknowledge its role at 650. At 650, a strategy elaboration dissemination may be performed. In this regard, a strategy for handling various requests within the smart space may be disseminated. At 655, the request may be synthesized with the strategy and, possibly, information provided by the information domain.

At 660, a distribution decision may be generated to determine the route of the request. In this regard, a per node inserts/retracts analysis may be performed at 665 and provided for inclusion in the distribution decision. A subscriptions analysis at 670 may also be performed and provided for inclusion in the distribution decision. The request may then be sent out at 675 based on a determined route.

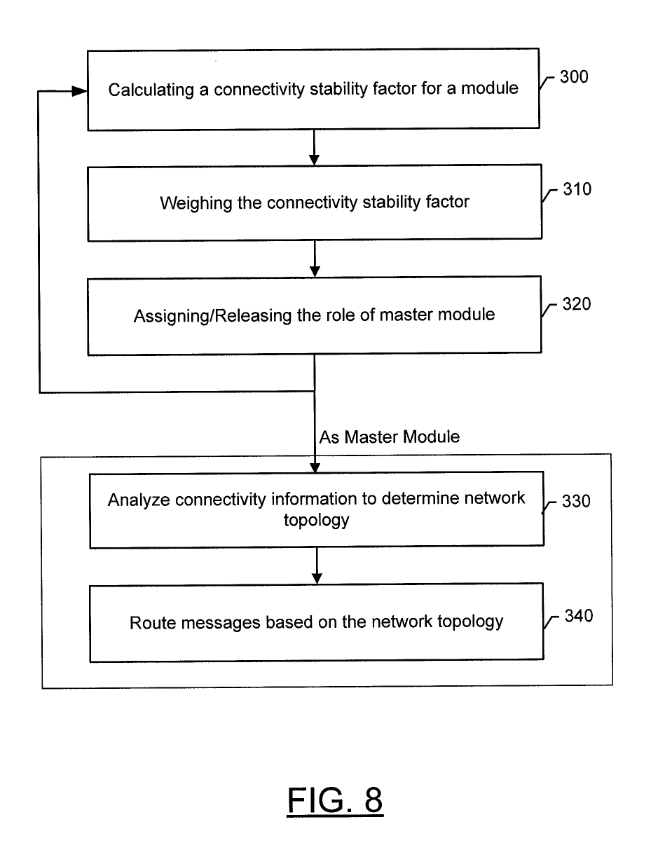

FIG. 7 illustrates an example apparatus 200 configured to determine a master module in a dynamic distributed device environment according to various embodiments of the present invention. The apparatus 200, and in particular the processor 205, may be configured to implement the operations described with respect to the SIBs and the smart spaces of FIGS. 1, 2a-2c, 3a-3b, 4a-4b, and 5a-5b as described above, and as generally described above. Further, the apparatus 200, and in particular the processor 205 may be configured to carry out some or all of the operations described with respect to FIGS. 6 and 8.

In some example embodiments, the apparatus 200 may be embodied as, or included as a component of, a computing device and/or a communications device with wired or wireless communications capabilities. Some examples of the apparatus 200 may include a computer, a server, a mobile terminal such as, a mobile telephone, a portable digital assistant (PDA), a pager, a mobile television, a gaming device, a mobile computer, a laptop computer, a camera, a video recorder, an audio/video player, a radio, and/or a global positioning system (GPS) device, a network entity such as an access point such as a base station, or any combination of the aforementioned, or the like. Further, the apparatus 200 may be configured to implement various aspects of the present invention as described herein including, for example, various example methods of the present invention, where the methods may be implemented by means of a hardware or software configured processor (e.g., processor 205), computer-readable medium, or the like.

The apparatus 200 may include or otherwise be in communication with a processor 205, a memory device 210, and a communications interface 215. Further, in some embodiments, such as embodiments where the apparatus 200 is a mobile terminal, the apparatus 200 also includes a user interface 225. The processor 205 may be embodied as various means including, for example, a microprocessor, a coprocessor, a controller, or various other processing devices including integrated circuits such as, for example, an ASIC (application specific integrated circuit), an FPGA (field programmable gate array), or a hardware accelerator. In an example embodiment, the processor 205 is configured to execute instructions stored in the memory device 210 or instructions otherwise accessible to the processor 205. Processor 205 may be configured to facilitate communications via the communications interface 215 by, for example, controlling hardware and/or software included in the communications interface 215.

The memory device 210 may be configured to store various information involved in implementing embodiments of the present invention such as, for example, connectivity stability factors. The memory device 210 may be a computer-readable storage medium that may include volatile and/or non-volatile memory. For example, memory device 210 may include Random Access Memory (RAM) including dynamic and/or static RAM, on-chip or off-chip cache memory, and/or the like. Further, memory device 210 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 210 may include a cache area for temporary storage of data. In this regard, some or all of memory device 210 may be included within the processor 205.

Further, the memory device 210 may be configured to store information, data, applications, computer-readable program code instructions, or the like for enabling the processor 205 and the apparatus 200 to carry out various functions in accordance with example embodiments of the present invention. For example, the memory device 210 could be configured to buffer input data for processing by the processor 205. Additionally, or alternatively, the memory device 210 may be configured to store instructions for execution by the processor 205.

The user interface 225 may be in communication with the processor 205 to receive user input at the user interface 225 and/or to provide output to a user as, for example, audible, visual, mechanical or other output indications. The user interface 225 may include, for example, a keyboard, a mouse, a joystick, a display (e.g., a touch screen display), a microphone, a speaker, or other input/output mechanisms. In some example embodiments, the display of the user interface 225 may be configured to present results of an analysis performed in accordance with embodiments of the present invention.

The communication interface 215 may be any device or means embodied in either hardware, software, or a combination of hardware and software that is configured to receive and/or transmit data from/to a network and/or any other device or module in communication with the apparatus 200. In this regard, the communication interface 215 may include, for example, an antenna, a transmitter, a receiver, a transceiver and/or supporting hardware, including a processor or software for enabling communications with network 220. In this regard, network 220 may be a smart space or other dynamic distributed device environment. Apparatus 200 may be a device that is part of a dynamic distributed device network (e.g., network 220) defined as a network where devices leave or enter the network at any time. In some example embodiments, network 220 may exemplify a peer-to-peer connection. Via the communication interface 215, the apparatus 200 may communicate with various other network entities.

The communications interface 215 may be configured to provide for communications in accordance with any wired or wireless communication standard. For example, communications interface 215 may be configured to provide for communications in accordance with second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 215 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like.

The stability analyzer 240 and the master module manager 245 of apparatus 200 may be any means or device embodied in hardware, software, or a combination of hardware and software, such as processor 205 implementing software instructions or a hardware configured processor 205, that is configured to carry out the functions of stability analyzer 240 and/or master module manager 245 as described herein. In an example embodiment, the processor 205 may include, or otherwise control stability analyzer 240 and/or master module manager 245. In various example embodiments, stability analyzer 240 and/or master module manager 245 may reside on differing apparatuses such that some or all of the functionality of stability analyzer 240 and/or master module manager 245 may be performed by a first apparatus, and the remainder of the functionality of stability analyzer 240 and/or master module manager 245 may be performed by one or more other apparatuses.

The stability analyzer 240 may be configured to calculate a connectivity stability factor for a module. In this regard, the module may be a module implemented by the processor 205, and in some example embodiments the module may be a SIB. The stability analyzer 240 may be configured to calculate the connectivity stability factor by performing a superposition operation on connectivity information provided, for example, by a connectivity controller. According to various example embodiments, the stability analyzer 204 may be configured to recalculate the connectivity stability factor of the module at regular or irregular intervals, possibly based on detected changes to the topology of the network.

The stability analyzer 240 may also be configured to weigh the connectivity stability factor of the module against neighboring connectivity stability factors associated with neighboring modules. In this regard, the stability analyzer 240 may be configured to determine whether the connectivity stability factor of the module describes a more or less stable module than the neighboring modules. Further, the stability analyzer 240 may be configured to weigh the connectivity stability factor of the module against neighboring connectivity stability factors each time a connectivity stability factor for the module is recalculated. In some example embodiments, the stability analyzer 204 may be configured to weigh the connectivity stability factor of the module against neighboring connectivity stability factors associated with neighboring modules, wherein the neighboring modules are SIBs. Further, in some example embodiments, stability analyzer 240 may be configured to identify the neighboring modules as modules with connectivity stability factors that exceed a threshold connectivity stability factor.

The master module manager 245 may be configured to assign a role of master module to a module based on a determination that the connectivity stability factor of the module describes a more stable module than the connectivity stability factors of neighboring modules. Further, the master module manager 245 may also be configured to release the role of master module based on a determination that the connectivity stability factor for the module describes a less stable module than at least one of the connectivity stability factors of the neighboring modules.

In embodiments where the master module is a module implemented by the processor 205, the master module manager 245 may be configured to receive messages from the neighboring modules, in some instances via a connectivity controller. The messages may include connectivity information of the network. In this regard, the master module manager 245 may also be configured to analyze the connectivity information to determine a network topology of the dynamic distributed device network to which the apparatus 200 and the master module belong. Further, the master module manager may also be configured to route messages within the dynamic distributed device network based on the network topology.

FIG. 8, and similarly FIG. 6 described above, illustrate a flowchart of a system, method, and computer program product according to example embodiments of the invention. It will be understood that each block, step, or operation of the flowcharts, and/or combinations of blocks, steps, or operations in the flowcharts, may be implemented by various means. Example means for implementing the blocks, steps, or operations of the flowcharts, and/or combinations of the blocks, steps or operations in the flowcharts include hardware, firmware, and/or software including one or more computer program code instructions, program instructions, or executable computer-readable program code instructions. Example means for implementing the blocks, steps, or operations of the flowcharts, and/or combinations of the blocks, steps or operations in the flowchart also include a processor such as the processor 205. The processor may, for example, be configured to perform the operations of FIG. 8 and/or the operations of FIG. 6 by performing hardware implemented logical functions, executing stored instructions, or executing algorithms for performing each of the operations. Alternatively, an example apparatus may comprise means for performing each of the operations of the flowcharts. In this regard, according to an example embodiment, examples of means for performing the operations of FIG. 8 and/or the operations of FIG. 6 include, for example, the processor 205, the stability analyzer 240, the master module manager 245, and/or an algorithm executed by the processor 205 for processing information as described above.

In one example embodiment, one or more of the procedures described herein are embodied by program code instructions. In this regard, the program code instructions which embody the procedures described herein may be stored by or on a memory device, such as memory device 210, of an apparatus, such as apparatus 200, and executed by a processor, such as the processor 205. As will be appreciated, any such program code instructions may be loaded onto a computer, processor, or other programmable apparatus (e.g., processor 205, memory device 210) to produce a machine, such that the instructions which execute on the computer, processor, or other programmable apparatus create means for implementing the functions specified in the flowcharts' block(s), step(s), or operation(s). In some example embodiments, these program code instructions are also stored in a computer-readable storage medium that directs a computer, a processor, or other programmable apparatus to function in a particular manner, such that the instructions stored in the computer-readable storage medium produce an article of manufacture including instruction means which implement the function specified in the flowcharts' block(s), step(s), or operation(s). The program code instructions may also be loaded onto a computer, processor, or other programmable apparatus to cause a series of operational steps to be performed on or by the computer, processor, or other programmable apparatus to produce a computer-implemented process such that the instructions which execute on the computer, processor, or other programmable apparatus provide steps for implementing the functions specified in the flowcharts' block(s), step(s), or operation(s).

Accordingly, blocks, steps, or operations of the flowcharts support combinations of means for performing the specified functions, combinations of steps for performing the specified functions, and program code instruction means for performing the specified functions. It will also be understood that, in some example embodiments, one or more blocks, steps, or operations of the flowcharts, and combinations of blocks, steps, or operations in the flowcharts, are implemented by special purpose hardware-based computer systems or processors which perform the specified functions or steps, or combinations of special purpose hardware and program code instructions.

FIG. 8 depicts a flowchart describing an example method for determining a master module in a dynamic distributed device environment, such as a smart space. At 300, the method may include calculating a connectivity stability factor for a module. In this regard, the module may be included on a device that is or is capable of being connected as a part of a dynamic distributed device network, and the dynamic distributed device network may be defined as a network where devices leave or enter the network at any time. Calculating the connectivity stability factor may include performing a superposition operation on connectivity information.

At 310, the method may include weighing, on a processor, the connectivity stability factor of the module against neighboring connectivity stability factors associated with neighboring modules. In this regard, the module and the neighboring modules may be SIBs. Further, the neighboring modules for weighing against may be defined by modules having associated neighboring connectivity stability factors that exceed a threshold connectivity stability factor

At 320, the method may include assigning a role of master module to the module based on a determination that the connectivity stability factor of the module describes a more stable module than the connectivity stability factors of the neighboring modules. At 320, the method may also include releasing the role of master module based on a determination that the connectivity stability factor for the module describes a less stable module than at least one of the connectivity stability factors of the neighboring modules. Upon assigning or releasing the role of master module, the method may revert back to operation 300 and recalculate the connectivity stability factor.

In embodiments where the method is being implemented by the master module, the method may further include analyzing the connectivity information to determine a network topology of the dynamic distributed device network at 330 and routing messages within the dynamic distributed device network based on the network topology at 340.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1 A method comprising:
calculating a connectivity stability factor for a module, the module being included on a device configured to be connected to a dynamic distributed device network;
weighing, on a processor, the connectivity stability factor of the module against neighboring connectivity stability factors associated with neighboring modules; and
assigning a role of master module to the module based on a determination that the connectivity stability factor of the module describes a more stable module than the connectivity stability factors of the neighboring modules.

2. The method of claim 1, wherein the module and the neighboring modules are semantic information brokers (SIBs).

3. The method of claim 1, wherein calculating the connectivity stability factor includes performing a superposition operation on connectivity information to determine the connectivity stability factor.

4. The method of claim 1 further comprising:
recalculating the connectivity stability factor for the module, the module having been assigned the role of master module;
weighing the recalculated connectivity stability factor against the neighboring connectivity stability factors; and
releasing the role of master module based on a determination that the connectivity stability factor for the module describes a less stable module than at least one of the connectivity stability factors of the neighboring modules.

5. The method of claim 1 further comprising:
analyzing the connectivity information to determine a network topology of the dynamic distributed device network; and
routing messages within the dynamic distributed device network based on the network topology.

6. The method of claim 1, wherein weighing the connectivity stability factor of the module against the neighboring connectivity stability factors associated with the neighboring modules includes the neighboring modules being associated with neighboring connectivity stability factors that exceed a threshold connectivity stability factor.

7. An apparatus comprising a processor, the processor configured to:
calculate a connectivity stability factor for a module, the module being included on a device configured to be connected to a dynamic distributed device network;
weigh the connectivity stability factor of the module against neighboring connectivity stability factors associated with neighboring modules; and
assign a role of master module to the module based on a determination that the connectivity stability factor of the module describes a more stable module than the connectivity stability factors of the neighboring modules.

8. The apparatus of claim 7, wherein the processor configured to weigh the connectivity stability factor of the module against neighboring connectivity stability factors associated with neighboring modules includes being configured to weigh the connectivity stability factor of the module against neighboring connectivity stability factors associated with neighboring modules, the module and the neighboring modules being semantic information brokers (SIBs).

9. The apparatus of claim 7, wherein the processor configured to calculate the connectivity stability factor includes being configured to perform a superposition operation on connectivity information to determine the connectivity stability factor.

10. The apparatus of claim 7, wherein the processor is further configured to:
recalculate the connectivity stability factor for the module, the module having been assigned the role of master module;
weigh the recalculated connectivity stability factor against the neighboring connectivity stability factors; and
release the role of master module based on a determination that the connectivity stability factor for the module describes a less stable module than at least one of the connectivity stability factors of the neighboring modules.

11. The apparatus of claim 7, wherein the processor is further configured to:
analyze the connectivity information to determine a network topology of the dynamic distributed device network; and
route messages within the dynamic distributed device network based on the network topology.

12. The apparatus of claim 7, wherein the processor configured to weigh the connectivity stability factor of the module against the neighboring connectivity stability factors associated with the neighboring modules includes being configured to weigh the connectivity stability factor of the module against the neighboring connectivity stability factors associated with the neighboring modules, the neighboring modules having associated neighboring connectivity stability factors that exceed a threshold connectivity stability factor.

13. The apparatus of claim 7 further comprising a memory device, the memory device storing computer-readable program code instructions accessible to the processor for configuring the processor.

14. A computer program product comprising at least one computer-readable storage medium having executable computer-readable program code instructions stored therein, the computer-readable program code instructions configured to cause an apparatus to:
calculate a connectivity stability factor for a module, the module being included on a device configured to be connected to a dynamic distributed device network;
weigh the connectivity stability factor of the module against neighboring connectivity stability factors associated with neighboring modules; and
assign a role of master module to the module based on a determination that the connectivity stability factor of the module describes a more stable module than the connectivity stability factors of the neighboring modules.

15. The computer program product of claim 14, wherein the computer-readable program code instructions configured to cause an apparatus to weigh the connectivity stability factor of the module against neighboring connectivity stability factors associated with neighboring modules include being configured to cause an apparatus to weigh the connectivity stability factor of the module against neighboring connectivity stability factors associated with neighboring modules, the module and the neighboring modules being semantic information brokers (SIBs).

16. The computer program product of claim 14, wherein the computer-readable program code instructions configured to cause an apparatus to calculate the connectivity stability factor include being configured to cause an apparatus to perform a superposition operation on connectivity information to determine the connectivity stability factor.

17. The computer program product of claim 14, wherein the computer-readable program code instructions are further configured to cause an apparatus to:
recalculate the connectivity stability factor for the module, the module having been assigned the role of master module;
weigh the recalculated connectivity stability factor against the neighboring connectivity stability factors; and
release the role of master module based on a determination that the connectivity stability factor for the module describes a less stable module than at least one of the connectivity stability factors of the neighboring modules.

18. The computer program product of claim 14, wherein the computer-readable program code instructions are further configured to cause an apparatus to:
analyze the connectivity information to determine a network topology of the dynamic distributed device network; and
route messages within the dynamic distributed device network based on the network topology.

19. The computer program product of claim 14, wherein the computer-readable program code instructions configured to cause an apparatus to weigh the connectivity stability factor of the module against the neighboring connectivity stability factors associated with the neighboring modules include being configured to cause an apparatus to weigh the connectivity stability factor of the module against the neighboring connectivity stability factors associated with the neighboring modules, the neighboring modules having associated neighboring connectivity stability factors that exceed a threshold connectivity stability factor.

20. An apparatus comprising:
means for calculating a connectivity stability factor for a module, the module being included on a device configured to be connected to a dynamic distributed device network;
means for weighing the connectivity stability factor of the module against neighboring connectivity stability factors associated with neighboring modules; and
means for assigning a role of master module to the module based on a determination that the connectivity stability factor of the module describes a more stable module than the connectivity stability factors of the neighboring modules.
